(19) United States
(12) Patent Application Publication
(10) Pub. No.: US 2021/0112151 A1
(43) Pub. Date: Apr. 15, 2021

(54) Method and System that Mitigates Digital Address Book Data Decay [TetherTap]

(71) Applicants: William Whitescarver, STUART, FL (US); GEORGE EVAN LADNER, WAXHAW, NC (US); ROBERT GRAHAM EELLS, ALBIA, IA (US); BRUCE JACKSON SHAW, MELBOURNE, FL (US)

(72) Inventors: William Whitescarver, STUART, FL (US); GEORGE EVAN LADNER, WAXHAW, NC (US); ROBERT GRAHAM EELLS, ALBIA, IA (US); BRUCE JACKSON SHAW, MELBOURNE, FL (US)

(21) Appl. No.: 17/031,845

(22) Filed: Sep. 24, 2020

Related U.S. Application Data
(60) Provisional application No. 62/906,359, filed on Sep. 26, 2019.

(51) Int. Cl. H04M 1/27457

(52) U.S. Cl. CPC H04M 1/27457

(57) ABSTRACT

A method is proposed to automatically, securely and directly notify and inform, selected contacts in the digital address book of a user's device when there is a change in the user's contact information. A system is proposed that does not require the user to store or maintain private data to any third party service server or central database repository in the cloud or not in the cloud. The proposed system employs TetherTap (“TT”) Privacy by Design (“PbD”) architecture resulting in full EU GDPR and California CCPA regulatory compliance, storing and transmitting data with default address book and peer to peer (“P2P”) communication platforms. The method proposed does not require receiver devices to be programmed with system functionality, however, it is designed to allow the receiver of an update from the user to set up and install reciprocal functionality.

### PARENT CASE TEXT

The present application claims the benefit of U.S. Provisional Patent Application Number 62906359, Confirmation Number 7723 on Sep. 26, 2019.

### DATE OF INVENTION

Conception and reduction to practice by collaboration between the inventors in order to apply for a patent began in the month of December 2018 leading to the filing of Provisional Patent Application Number 62906359 on Sep. 26, 2019. (Confirmation Number 7723),

### FIELD

Digital Communications Architecture applied to digital address book contacts information maintenance and technologies.

### BASIC INVENTION DESCRIPTION

The TetherTap (“TT”) technology is a method and system that employs automated secure decentralized technology to mitigate digital address book data decay in the ecosystem of digital address book users, in order to simplify digital contact list maintenance and updating, within a Privacy by Design framework for users of digital communications.

### CROSS-REFERENCE TO RELATED APPLICATIONS

U.S. Patent Documents

| | | |
|---|---|---|
| 9,117,181 | August 2015 | Fox, et al. |
| 9,332,073 | May 2016 | Li, et al. |
| 10/354,229 (20100030858) | July 2019 | Chasin |
| 7,933,587 | April 2011 | Swan |
| 8,370,482 | February 2013 | Shustef |
| 9,298,762 | March 2016 | Smarr, et al. |
| 9,386,020 | July 2016 | Gold, et al. |
| 8,660,602 | February 2014 | Akhtar, et al |
| 9,442,953 | September 2016 | Mitchell |
| 8,478,906 | July 2013 | Jordan |
| 7,822,191 | October 2010 | McKinzie, et al. |
| 6,931,419 | August 2005 | Lindquist |
| 9,697,289 | July 2017 | Gropper |
| 7,818,382 | October 2010 | Sommerer |
| 8,972,505 | March 2015 | Zheng, et al. |
| 8,805,417 | August 2014 | Angiolillo |
| 10/558,673 | February 2020 | Lee |
| 7,007,068 | February 2006 | Morkel |
| 8,983,550 | March 2015 | Narayanachar |
| 8,750,851 | June 2014 | Le Thierry d'Ennequin |
| 7,337,448 | February 2008 | Dalia, et al. |
| 7,409,466 | August 2008 | Yang |

### BACKGROUND OF THE INVENTION

Digital address book data decay is a substantial problem in today's digital communications ecosystem. The annual rate of contact data decay is 22.5%. Solving that problem can simplify a digital user's digital contact list maintenance burden and thereby improve the landscape of the Internet. There are many attempts in the public domain to solve this problem that fail to provide digital users with the control, privacy by design, and safety of personal information that is critical for trustworthy internet communications. This invention application details a method and system that provides the innovative TT approach that is useful to digital users and is not obvious to the state of the art in digital communications.

DATA DECAY is a term used in information technology that applies to static database fields representing dynamic information which over the course of time, can change. If the occurrence of such a change is no longer reflected in that data field the integrity of the database is lost along with its capability to provide a user with the intended use of that datum. With regard to digital address books, contact information such as email address, phone number, mailing address etc. are subject to change and therefore require continuous database maintenance in order to mitigate data decay.

PbD—Privacy (and Data Protection) by design and by default is written into Article 25 of the EU GDPR. Privacy by Default means that once a digital product, service, method or system has been released to the public, the strictest privacy settings must apply by default, without any manual input from the end user.

### BRIEF SUMMARY OF THE INVENTION

The present invention seeks to automate the task of maintaining up to date device electronic contact address books. Advantageously the invention only requires programmed functionality by one user's device, enabling them to have their contact information automatically maintained in the device digital address books of their preferred contacts. Provisions are made for an optionally installed program on the contact's device allowing for the automatic maintenance of contact update messages sent from the contacts back to the original user device and to their digital address book contacts.

A method is proposed to securely mitigate digital address book data decay for digital users using no centralized data collection infrastructure. Person to person data transmission, using native and or 3rd party digital device messaging platforms, protects against compromise of users private information due to database breaches and enables users to control the dissemination of their data. A system is proposed that enables the adoption of such address book functionality. The system allows users to select address book contacts that will be automatically notified, by asynchronous messaging, of critical changes to that user's contact information. Upon such notification, the receiver is given an option to update address book and to enable reciprocal (synchronous) functionality on the receiver's device. When the receiver opts in, automatic updating and exchange of the contact list information on that device will be enabled.

The following digital address book features are enabled by this invention:
Effortless mitigation of data decay—Automatic updating of user's address book prompted by a change in the contact's profile
Privacy by Design—users control the dissemination of their data by default.
Seamless UX—No touch add and change contact information using preferred digital address books
A system that provides connection mapping driven by permissions matrices
Nothing to remember—Opt-in response to non-intrusive iterative system generated update alerts.
Nothing to learn (Zero user learning curve)—painless adoption with cross platform capability

In some embodiments, the system and method of the present invention comprises integration with any existing digital email platform, in other embodiments, the system and method of the present invention comprises integration with any digital CRM. SMS, MMS, telephony platform, and in further embodiments the system and method of the present invention comprises integration with USPS mail, billing, shipping, conferencing, social media, and other digital relationship tracking and management platforms, methods, systems, and digital ecosystems. It is to be understood that the above- described embodiments are simply illustrative of the principles of the invention. Various and other modifications, alterations, and variations may be made by those skilled in the art which will embody the principles of the invention and fall within the spirit and scope of the claims herewith.

Structural Alternative

If direct messaging is not accessible, a secure relay service that does not store any data is utilized to facilitate the communication process by both encrypted and unencrypted methods . This does not violate the core principle of data protection enabled by the elimination of the central database framework in compliance with PbD specification.

Alternate Use

This invention is specific to the use case and operational results presented in this application. Changing the functions of any of the component parts described would not be practical in that all of the components are critical to the benefits and features of the invention. Technologies that could make the invention work better are not available in a practical manner at this time.

In some embodiments, the system and method of the present invention comprises integration with any existing digital email platform, in other embodiments, the system and method of the present invention comprises integration with any digital CRM. SMS, MMS, telephony platform, and in further embodiments the system and method of the present invention comprises integration with USPS mail, billing, shipping, conferencing, social media, and other digital relationship tracking and management platforms, methods, systems, and digital ecosystems.

It will be apparent to those skilled in the art that various modifications may be made in the present invention, without departing from the spirit or scope of the invention. Thus, it is intended that the present invention cover the modifications and variations of this invention provided they come within the scope of the claims herewith and their equivalents.

Limitations

Functionality of this invention is dependent on digital application development platform policies and restrictions and the digital device features that are native or added that allow for the interaction of the system components required to provide the operational results.

Potential Commercialization:

A commercial product that is developed using the method and system detailed in this application as a digital utility, tool or application, has the potential to be used and purchased by digital users who desire perpetual, accurate, safe and private communication channels for both personal and business contacts.

State of the Art

There are methods and systems that exist within digital platforms to perform the same function as this invention, in a way that uses centralized database frameworks, which expose personal and business contact information to data breach vulnerabilities and limit the user's control of private information in violation of PbD specifications. This invention produces similar results without exposing the user to those vulnerabilities while automatically providing user's control of private information in compliance with PbD specifications.

There are methods and systems that exist within digital platforms to perform the same function as this invention that require both the sender and receiver devices of a contact information update to have the programmed functionality installed. This invention's TT technology is only required to be installed on the device of the sender of updated contact information.

Currently when a user's contact information changes, the user is able to manually notify by direct communication any of the contacts in the user's address book, of the change, individually, which combines the contemporary components of a device's address book and messaging capability, providing data protection similar to that of this invention. This invention, however, enables an automatic bulk method and system for such functionality, that replaces the manual method, by leveraging the data provided by the pre-selected TT list of contacts (Innovational System Part 2) while allowing for a peer to peer reciprocal exchange of contact data not using a centralized data collection Since the process is automated and simplified, users are incentivized to better maintain contact information systems that are currently assiduous and subject to data decay, compromised control of data, and nefarious attacks.

Patentability:

To the best of our knowledge, this invention is not already patented, or described in a printed publication, or in public use or on sale either:
By others, before this patent application, or:
By anyone, more than one year before this application.
This invention has never been shown or used in public.

Resources for Search:

All available sources have been exhausted.
USPTO Patent search.
Technical blogs on the internet.
Legacy library resources.
Google search.
Apple App Store.
Google Play Store.

### STATEMENT REGARDING FEDERALLY SPONSORED R&D

### Rights of Others

There are no obligations to assign any rights in the invention to others
This invention was not developed in the course of employment, or using any facilities belonging to any employer or the US Government.
This invention was not developed in the course of a consulting agreement with someone else
There was no funding of the development of the invention by any party (government agency, school, etc.) who might claim rights in the invention
There were no equipment or facilities used in the development of the invention which was funded by or belongs to any government agency.

### Other Inventors

There are no other inventors to be named in this application

### BRIEF DESCRIPTION OF THE DRAWINGS

FIG. 1 Illustrates a block diagram detailing the flow of data as it moves from a user's device to the selected recipient contacts. The flow of data is identical for both the process of System Install and Set UP and the Method of Operation.

FIG. 2 Illustrates a process diagram of System Install and Set Up on a user's device that generates a notification to the selected recipients' devices where the recipient options are determined.

FIG. 3 Illustrates a process diagram of the Method of Operation where a change in the users contact profile generates a notification to the selected recipients' devices where the recipient options are determined.

### DETAILED DESCRIPTION

Essential System Components that Contribute to the Invention

This invention requires the following system components that are innovative and interact with parts that are conventional:
Conventional Systems Part 1—User digital devices are generally equipped with address book databases with records containing the personal and/or business contact information of people that the user can refer to in order to communicate with others over various communication platforms.
Conventional Systems Part 2—User digital devices are generally equipped with digital messaging systems that reside on a user's digital device that is able to communicate directly with other digital devices (person to person) utilizing available internet/wireless communication infrastructure.
Conventional Systems Part 3—User digital devices generally have functionality that enables direct transfer of information from one device to another using Near Field Communication and QR Code, WIFI, and bluetooth technologies.
Conventional System Part 4—The addition of, or integration with a user profile record or multiple user profiles that exist on the user's digital device, that contain the user's personal and/or business contact information that enables others to communicate with the user over various communication platforms.
Innovative System Part 1—The user device profile record integrates a TT user selected timed tracking capability that prompts the user to do a review of the user profile for any updates that are appropriate.
Innovative System Part 2—The addition of a user device listing of address book contacts that will be included in the TT notification network specified by the user. The TT notification network may also be identified using a field in the contact record.
Innovative System Part 3—The TT notification network internal to the user's device enables identification of the context of the relationship between the contacts and the user, and a tracking of the last update transmission performed while also adding more information not traditionally included with address book data, including messaging opt-in/opt-out status.
Innovative System Part 4—A method by which the receiver of a TT update transmission will be enabled to acquire a reciprocal TT capability, internal to the receiver device, should the receiver choose such an option.

Detailed Interaction of System Components

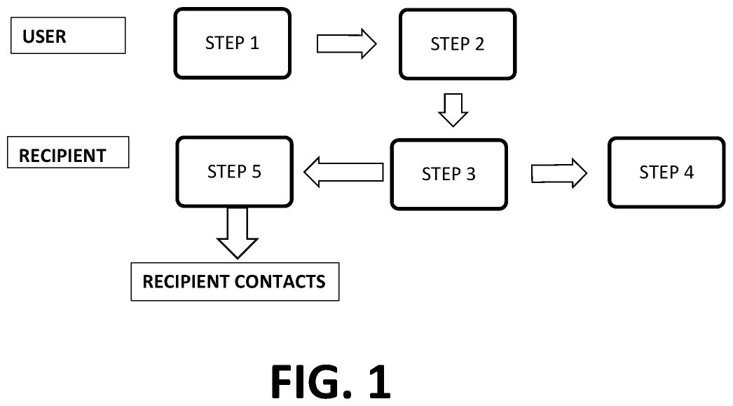

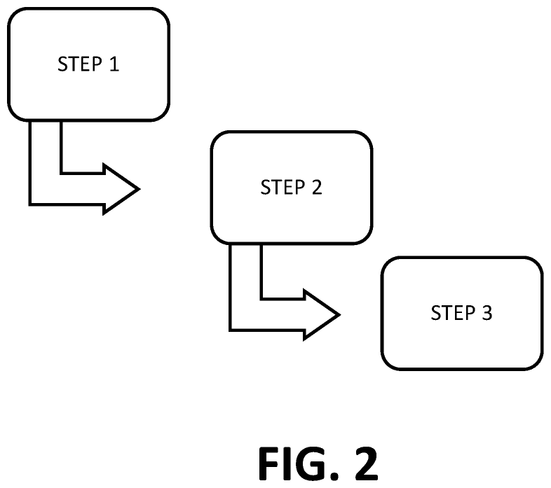

The following steps are required to set-up the TT system on a user's device:
1. Address book contact records are created when a user elects to store a contact's information on the user's device by manually entering, or by automated means, entering data fields or by using the device's native automatic data transfer functionalities such as text and email extraction, NFC, QR Code, WIFI, or bluetooth technologies. Address book contact records exchange between multiple devices simultaneously is enabled using these device automatic data transfer functionalities.
2. The user specifies a TT profile or profiles on the user's digital device with a reminder period specification FIG. 1, Step 1, FIG. 2, Step 1
3. The user specifies the user's address book contacts to be notified should the user's chosen profile information change, with an option to specify the context of relationship and other information that is not traditionally included in address book records such as messaging opt-in/opt-out status. Contacts can also be pre-selected by the system based on groups and/or email platforms which are identifiable by address extensions. FIG. 1, Step 2, FIG. 2, Step 2,
4. The address book contacts specified by the user are notified, and receive by direct person to person messaging, that they are included in the user's TT network of contacts that are to be notified should the user's profile information change. FIG. 2, Step 3
5. The contacts specified by the user are offered an option and instructions to set-up reciprocal TT functionality systems on their device and an option to opt-in/out of future notifications. FIG. 1, Step 3, FIG. 2, Step 4

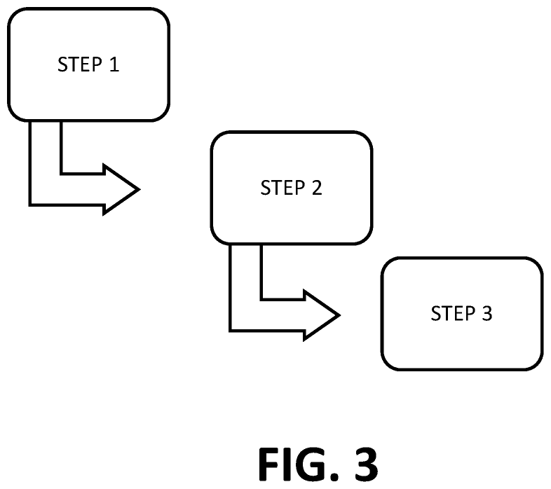

The following steps define the method of operation: FIG. 3
1. The user makes a change in the TT profile contact information FIG. 1, Step 1, FIG. 3, Step 1.
2. The address book contacts pre-selected by the user are automatically notified, and receive by direct messaging, that the user has changed TT profile contact information. FIG. 1, Step 2, FIG. 3, Step 2
3. The receiver of the notification is presented with the following options: FIG. 1, Step 3, FIG. 3, Step 3
   a. Manual address book update FIG. 1, Step 4
   b. Automatic address book update FIG. 1, Step 5
   c. Set-up on device of reciprocal TT system functionality FIG. 1, Step 5
   d. Opt-in/opt-out of future TT notification messages. FIG. 3, Step 3

1. A method and system that enables updating of a user's contact information to contacts within a user's digital address book that is default to a user's device using automated secure decentralized communications technology that is default to a user's device, in order to mitigate digital address book data decay, while leveraging Privacy (and Data Protection) by design and by default protocols.

2. A method according to claim 1 wherein the plurality of electronic messages are automatically generated within the user's device, not utilizing external or third-party servers.

3. The method of claim 1 wherein the existing contact information is transmitted and received via device default peer to peer communication technologies.

4. A method according to claim 1 wherein a mechanism is provided whereby automatic and periodic notifications are generated by the user's device to send changes to address book contacts.

5. A method according to claim 1 wherein a mechanism is provided whereby the addressee is enabled to synchronously opt/in to the system proposed in this application.

6. A method generating a plurality of electronic messages in order to inform a plurality of addressees included in the address book contact database of a digital user's digital device in order to automatically transmit and update or maintain the user's contact information fields within an address book contact database of a predetermined plurality of the addressees, without requiring an individual to manually update same.

7. A method of claim 6 wherein a mechanism is provided that assigns a tag to each address book contact as either personal, business or other designation.

8. A method according to claim 6 wherein a mechanism is provided whereby users can deliver their contact information to addressees.

9. A method according to claim 6 wherein each electronic message generated by the user's device, of the plurality of electronic messages, includes the contact information of the user and the addressee, for display within a body of the electronic message.

10. The method of claim 6, wherein the contact information comprises at least one of an email address, a name, a residential address, a business address, a company name, a business phone number, a home phone number, a mobile phone number, a fax number or any other contact and relationship information a user may want to include as an update to address book contacts.

11. The method of claim 6, wherein the contact information to be updated includes existing contact information associated with the addressee.

12. The method of claim 6, wherein at least one of the contact information or the messaging data is modifiable by the computing device.

13. The method of claim 6 further comprising: conditions causing the recipient addressee to automatically or manually write the updated contact information to a digital address book.

14. The method of claim 6, wherein updated contact information is received by the addressee if the user (i) provided an update to the contact information or (ii) a confirmation of the contact information (or) when an addressee is selected to be included in future update notification cycles.

15. We claim the method and system comprising any feature described either individually or in combination with any feature, in any configuration.
